(19) United States
(12) Patent Application Publication
(10) Pub. No.: US 2025/0044477 A1
(43) Pub. Date: Feb. 6, 2025

(54) TITLE: METHOD AND SYSTEMS FOR DETERMINATION FRACTURE WIDTH AND FRACTURE CONDUCTIVITY USING COMBINED ANALYSIS OF WELLBORE IMAGES AND LOW-FREQUENCY STONELEY WAVE MEASUREMENTS

(71) Applicant: BRIAN EDWARD HORNBY, Fulshear, TX, TX (US)

(72) Inventor: BRIAN EDWARD HORNBY, Fulshear, TX, TX (US)

(73) Assignee: Hornby Geophysical Services, Fulshear, TX (US)

(21) Appl. No.: 18/792,860

(22) Filed: Aug. 2, 2024

Related U.S. Application Data
(60) Provisional application No. 63/530,312, filed on Aug. 2, 2023.

(51) Int. Cl. G01V 11/00; E21B 49/00

(52) U.S. Cl. CPC G01V 11/002; E21B 49/00

(57) ABSTRACT

Systems and methods are disclosed for determining a hydraulic fracture aperture within a subsurface region of interest. The methods may include obtaining, from a wellbore imaging tool, an image of a portion of a wellbore wall, wherein the wellbore penetrates the subsurface region of interest, obtaining, from a sonic logging tool, a full waveform sonic dataset for the portion, and identifying, using a well log interpretation system, a location of each member of a plurality of fractures in the image. The method may further include using a full waveform sonic processing system, for each member of the plurality of fractures, identifying a reflected sonic signal originating at the location of the fractures, and determining, from the reflected sonic signal, a hydraulic aperture.

### CROSS REFERENCE TO RELATED APPLICATIONS

This application claims priority to U.S. Provisional Application Ser. No. 63/530,312 filed Aug. 2, 2023, entitled “IMPROVED DETERMINATION OF FRACTURE WIDTH AND FRACTURE CONDUCTIVITY USING A COMBINED ANALYSIS OF ELECTRICAL BOREHOLE IMAGES ACQUIRED USING ELECTRICAL BOREHOLE WALL IMAGING TOOLS AND LOW-FREQUENCY STONELEY WAVE MEASUREMENTS ACQUIRED USING MONOPOLE BOREHOLE SONIC TOOLS.”, hereby incorporated by reference.

### TECHNICAL FIELD

The present technology pertains to geophysical prospecting and, more specifically, to evaluating wellbore subsurface geologies and fluid motion therein.

### BACKGROUND

Natural fractures in subsurface geological formations form important conduits for the flow of fluid including water in aquifers and oil and gas in hydrocarbon reservoirs. Accurate simulation of this flow in important for the prediction of future fluid production from wells penetrating the subsurface and for determining beneficial stimulation and production strategies and actions.

Accurate simulation of fluid flow requires a detailed knowledge of the distributions of the orientation and apertures of hydraulically conductive fractures to be used to populate reservoir simulation models. Unfortunately, it can be difficult using conventional methods to distinguish hydraulically conductive fractures that extend far from a wellbore from hydraulically non-conductive fractures that form in the immediate vicinity of the wellbore due to mechanical damage and stress field alterations that occur when the well is drilled.

Accordingly, there exists a need for determining the orientation and hydraulic aperture of fractures within subsurface geological formations.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method for determining a hydraulic fracture aperture within a subsurface region of interest. The methods may include obtaining, from a wellbore imaging tool, an image of a portion of a wellbore wall, wherein the wellbore penetrates the subsurface region of interest, obtaining, from a sonic logging tool, a full waveform sonic dataset for the portion, and identifying, using a well log interpretation system, a location of each member of a plurality of fractures in the image. The method may further include using a full waveform sonic processing system, for each member of the plurality of fractures, identifying a reflected sonic signal originating at the location of the fractures, and determining, from the reflected sonic signal, a hydraulic aperture.

In one aspect, embodiments disclosed herein relate to a non-transitory computer-readable memory having computer-executable instructions stored thereon that, when executed by a computer processor, causes the computer processor to perform steps including receiving, from a wellbore imaging tool, an image of a portion of a wellbore wall, wherein the wellbore penetrates the subsurface region of interest and receiving, from a sonic logging tool, a full waveform sonic dataset for the portion. The steps may further include identifying, using a well log interpretation system, a location of each member of a plurality of fractures in the image; and for each member of the plurality of fractures, identifying a reflected sonic signal originating at the location of the fractures, and determining, from the reflected sonic signal, a hydraulic aperture.

In one aspect, embodiments disclosed herein relate to a system for determining a hydraulic fracture aperture within a subsurface region of interest, including a wellbore imaging tool, configured to obtain an image of a portion of a wellbore wall, wherein the wellbore penetrates the subsurface region of interest a sonic logging tool, configured to obtain a full waveform sonic dataset for the portion a well log interpretation system, configured to identify a location of each member of a plurality of fractures in the image, and a full waveform sonic processing system. The full waveform sonic processing system is configured to identify, for each member of the plurality of fractures, a reflected sonic signal originating at the location of the fractures, and determine, for each member of the plurality of fractures, from the reflected sonic signal, a hydraulic aperture.

Any combinations of the various embodiments and implementations disclosed herein can be used in a further embodiment, consistent with the disclosure. Other aspects and advantages of the claimed subject matter will be apparent from the following description and the appended claims.

### BRIEF DESCRIPTION OF DRAWINGS

The embodiments herein may be better understood by referring to the following description in conjunction with the accompanying drawings in which like reference numerals indicate analogous, identical, or functionally similar elements. Understanding that these drawings depict only exemplary embodiments of the disclosure and are not therefore to be considered to be limiting of its scope, the principles herein are described and explained with additional specificity and detail through the use of the accompanying drawings in which:

FIG. 1A schematically depicts a wellbore environment and a logging-while-drilling (LWD) system in accordance with one or more embodiments”

FIG. 1B schematically depicts a wellbore environment showing a downhole wireline logging operation in accordance with one or more embodiments;

FIG. 2A depicts an electrical wellbore wall imaging device in accordance with one or more embodiments;

FIG. 2B depicts a wellbore wall intersected by a dipping fracture in accordance with one or more embodiments;

FIG. 2C depicts the trajectory of a dipping fracture interesting a wellbore wall in accordance with one or more embodiments;

FIG. 2D shows wellbore wall image data together with interpreted fractures intersecting the wellbore wall, in accordance with one or more embodiments;

FIG. 3 illustrates the electrical wellbore data for a single, thin fracture along with determination of the fracture aperture for each location of the fracture around the wellbore in accordance with one or more embodiments;

FIG. 4 illustrates a wellbore sonic tool deployed in a wellbore with Stoneley wave signals encountering a fracture crossing the wellbore and reflected sonic signals emanating therefrom in accordance with one or more embodiments;

FIG. 5A shows an example of raw recorded Stoneley wave data in accordance with one or more embodiments;

FIG. 5B shows and example plot of signal amplitude versus frequency of Stoneley wave data according to the preferred embodiments of the present invention in accordance with one or more embodiments;

FIG. 6 illustrates an iso-offset display of raw Stoneley wave data for a single source receiver pair along with deconvolved Stoneley wave reflectivity in accordance with one or more embodiments;

FIG. 7 displays a graph of theoretical curves showing the Stoneley wave reflectivity response as a function of frequency for a range of hydraulic fracture apertures in accordance with one or more embodiments;

FIG. 8A depicts a wellbore sonic tool encountering a washout with a fracture intersecting the wellbore inside the washout area in accordance with one or more embodiments;

FIG. 8B shows a graph of theoretical curves showing the Stoneley wave reflectivity response as a function of frequency for a single fracture with a range of wellbore conditions in accordance with one or more embodiments;

FIG. 9 shows a log of wellbore diameter, Stoneley wave reflectivity for different frequencies, Stoneley wave continuous and electrical wellbore scan identified fracture apertures, and aggregate hydraulic fracture aperture for identified fractures crossing the wellbore in accordance with one or more embodiments;

FIG. 10 shows a log of wellbore diameter, Stoneley wave reflectivity for different frequencies, Stoneley wave continuous fracture aperture, and Stoneley wave determined hydraulic fracture aperture for identified fractures crossing the wellbore in accordance with one or more embodiments;

FIG. 11 shows determined hydraulic fracture aperture for identified fractures crossing the wellbore for a large wellbore section in accordance with one or more embodiments;

FIG. 12 depicts a reservoir model penetrated by 3 wellbores in accordance with one or more embodiments;

FIG. 13 depicts a discrete fracture network model estimated, in part, using wellbore interpreted hydraulic fracture aperture in accordance with one or more embodiments;

FIG. 14 depicts a reservoir simulation grid in accordance with one or more embodiments;

FIG. 15 illustrates a discrete fracture network in accordance with one or more embodiments;

FIG. 16 depicts a computer system in accordance with one or more embodiments,

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. For example, a fracture may reference two or more such fractures.

As used here and in the appended claims, the words “comprise,” “has,” and “include” and all grammatical variations thereof are each intended to have an open, non-limiting meaning that does not exclude additional elements or steps.

“Optionally” means that the subsequently described event or circumstances may or may not occur. The description includes instances where the event or circumstance occurs and instances where it does not occur.

Terms such as “approximately,” “about,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide. For example, these terms may mean that there can be a variance in value of up to +10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

It is to be understood that one or more of the steps shown in a flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

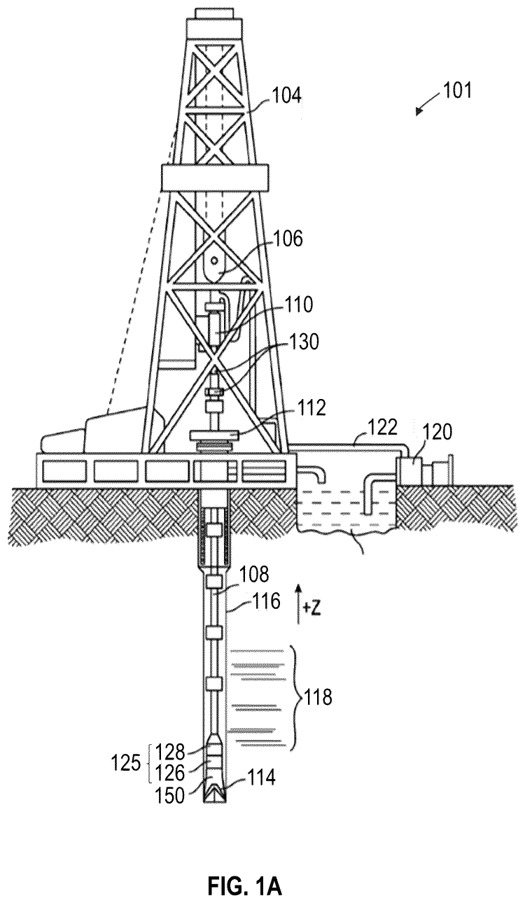

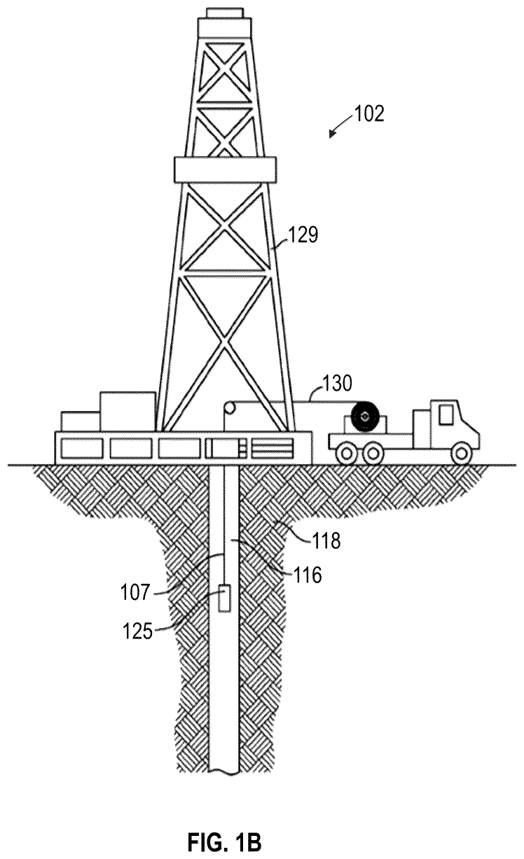

In the following description of FIGS. 1-19, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

The disclosed invention relates to using multi-physics and complementary wellbore measurements to deliver an estimation of hydraulic fracture aperture for fractures crossing a wellbore along with a determination that the fracture is either hydraulically conductive and extends beyond the wellbore or is truncated close to the well and so is not hydraulically conductive. Wellbore wall imaging measurements can deliver accurate high-resolution properties of fractures crossing a wellbore, including depth location, dip, and direction. Acoustic measurements use monopole wellbore sonic data to generate low-frequency Stoneley wave measurements to “pressure test” the fractures and deliver an estimation of hydraulic fracture aperture.

Acquisition and analysis of wellbore wall imaging data is crucial to identify local stress directions and locate natural and drilling-induced fractures crossing a wellbore. Conventional wellbore wall imaging tools use electrical, ultrasonic, or optical measurements. Electrical wellbore wall imaging tool measurements can be used to estimate a hydraulic fracture aperture based on quantification of the additional current flow injected into the fracture. However, a limitation of electrical wellbore wall imaging hydraulic fracture aperture determination is that measurements are at the wellbore wall and analysis cannot differentiate between fractures extending beyond the wellbore (and possibly connecting to extensive natural fracture networks), and fractures terminating near the wellbore. To complement the electrical wellbore wall imaging hydraulic fracture aperture result and to deliver a hydraulic fracture aperture estimation for non-electrical wellbore wall imaging devices Stoneley wave measurements are disclosed herein that may be used for deeper investigation of hydraulically conductive fractures using secondary Stoneley wave arrivals caused by pressure released into the fractures. In essence the Stoneley wave, upon encountering a fracture crossing the wellbore, will create a reflected Stoneley wave signal whose amplitude is proportional to the aperture of the fractures. This measurement will only reflect apertures of fractures that extend away from the wellbore and so will show little signal when the fractures terminated near the wellbore. The objective of this invention is to create an integrated workflow using both measurements to create high-quality estimations of hydraulic fracture apertures of hydraulically conductive fractures crossing a wellbore. These results can then be used to high-grade wellbore sections for well stimulation, for example, or to provide “ground truth” hydraulic fracture location and properties to facilitate Discrete Fracture Network (DFN) modeling to impact reservoir management. Accordingly, the systems and methods disclosed herein form a significant improvement of the system and methods disclosed in the prior art.

With reference to the figures, FIG. 1A provides a schematic diagram of a wellbore environment 101, particularly showing logging while drilling (LWD) operations, in which the presently disclosed techniques may be deployed. As depicted, wellbore environment 101 includes a drilling platform 102 equipped with a derrick 104 that supports a hoist 106 for raising and lowering a drill string 108. Hoist 106 suspends a top drive 110 suitable for rotating the drill string 108 and lowering drill string 108 through a well head 112. Connected to a lower end of drill string 108 is a drill bit 114. As drill bit 114 rotates, drill bit 114 creates a wellbore 116 that passes through various formations 118. A pump 120 circulates drilling fluid through a supply pipe 122 to top drive 110, down through an interior of drill string 108, through orifices in drill bit 114, back to the surface via an annulus around drill string 108, and into a retention pit 124. The drilling fluid transports cuttings from wellbore 116 into pit 124 and aids in maintaining the integrity of wellbore 116. Various materials can be used for drilling fluid, including oil-based fluids and water-based fluids.

Logging tools 126 can be integrated into a bottom-hole assembly 125 near drill bit 114. As drill bit 114 extends wellbore 116 through subsurface formations 118, logging tools 126 collect measurements relating to various formation properties as well as the orientation of the tool and various other drilling conditions. A bottom-hole assembly 125 may also include a telemetry sub 128 to transfer measurement data to a surface receiver 130 and to receive commands from the surface. In at least some cases, telemetry sub 128 communicates with a surface receiver 130 using mud pulse telemetry. In some instances, telemetry sub 128 does not communicate with the surface, but rather stores logging data for later retrieval at the surface when the logging assembly is recovered.

Each of logging tools 126 may include a plurality of tool components, spaced apart from each other, and communicatively coupled with one or more wires. Logging tools 126 may also include one or more computing devices 150 communicatively coupled with one or more of the plurality of tool components by one or more wires. A computing device 150 may be configured to control or monitor the performance of the tool, process logging data, and/or carry out the methods of the present disclosure.

In at least some instances, one or more of logging tools 126 may communicate with a surface receiver 130 by a wire, such as wired drill pipe. In other cases, the one or more of logging tools 126 may communicate with a surface receiver 130 by wireless signal transmission. In at least some cases, one or more of logging tools 126 may receive electrical power from a wire that extends to the surface, including wires extending through a wired drill pipe. In at least some instances the methods and techniques of the present disclosure may be performed by a computing device (not shown) on the surface. In some embodiments, the computing device may be included in surface receiver 130. For example, surface receiver 130 of wellbore operating environment 100 at the surface may include one or more of wireless telemetry, processor circuitry, or memory facilities, such as to support substantially real-time processing of data received from one or more of the logging tools 126. In some embodiments, data is processed at some time subsequent to its collection, wherein the data may be stored on the surface at surface receiver 130, stored downhole in telemetry sub 128, or both, until it is retrieved for processing.

FIG. 1B provides another schematic diagram of conveyance logging wellbore operating environment 102, also referred to in the field as “wireline.” For example, instead of using drill string 108 of FIG. 1A to lower tool body 110, which may contain sensors or other instrumentation for detecting and logging nearby characteristics and conditions of the wellbore and surrounding formation, the logging tool 125 can be lowered into the wellbore 116 by a conveyance 130 as shown in FIG. 1B. Notably, conveyance 130 can be anchored in drill rig 129 or by other portable means such as a truck. Conveyance 130 can include one or more wires, slicklines, cables, or the like, as well as tubular conveyances such as coiled tubing, joint tubing, or other tubulars and may include a downhole tractor. Further, conveyance 130 provides support for logging tool 125 such as communication between local and remote tool processors (e.g., fiber optic cabling, etc.) and power. When employing non-conductive conveyances, such as cable, coiled tubing, pipe string, or downhole tractor, communication may be supported using, for example, wireless protocols (e.g. EM, acoustic, etc.), and/or measurements and logging data may be stored in local memory for subsequent retrieval. For slickline or coiled tubing configurations, power can be supplied downhole with a battery or via a downhole generator.

In operation, subsurface formation 118 is traversed by a wellbore 116, which may be filled with drilling fluid or mud (not shown). Logging tool 125 is lowered into wellbore 116 by cable 107. As discussed, cable 107 connects to surface equipment (not shown) such as sheave wheels, derricks, winches, and the like, which operate to control descent/ascent of logging tool 125 through wellbore 104. In addition, cable 107 may include electrical wiring and other electrical components that facilitate communication between logging tool 125 and the surface equipment. In addition, in also appreciated logging tool 125 may be configured for wireless communications. In this fashion, logging tool 125 may be equipped with various types of electronic sensors, transmitters, receivers, hardware, software, and/or additional interface circuitry for generating, transmitting, and detecting signals (e.g., sonic waves, etc.), storing information (e.g., log data), communicating with additional equipment (e.g., surface equipment, processors, memory, clocks, input/output circuitry, etc.), and the like. It is appreciated by those skilled in the art that various types of logging tools/devices may be used in conjunction with the techniques disclosed herein and that the environments shown in FIGS. 1A and 1B are provided as examples for discussion, not limitation.

Wellbore wall imaging is an important measurement for investigating and quantifying the wellbore dimensions and features crossing the wellbore. These imaging devices are primarily implemented by electrical or ultrasonic measurements; however other measurements, such as video camera or gamma-ray imaging, may be employed and can also provide wellbore wall imaging.

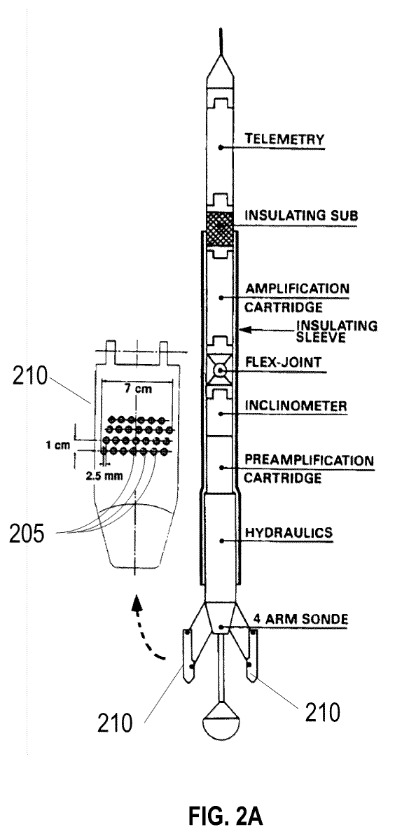

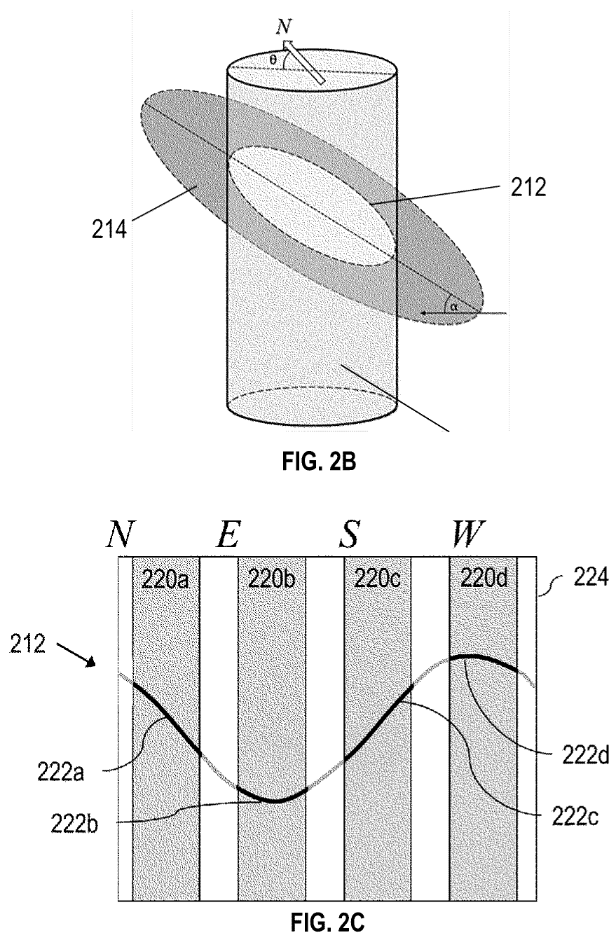

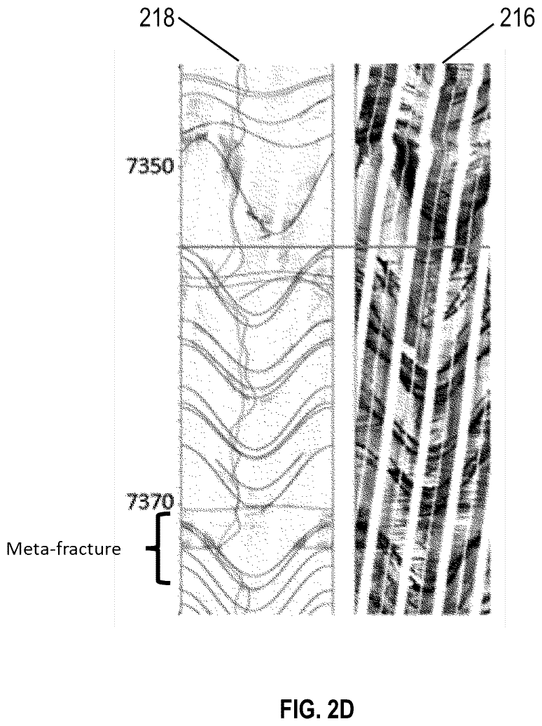

FIG. 2A illustrates an electrical wellbore wall imaging tool. The electrical wellbore wall imaging tool typically has a number of electrodes 205 implanted on a pad 210 that is configured to press against the wall of the wellbore. The resulting images can identify wellbore washouts or caves or enlargements due to other reasons, bedding crossing the wellbore, and fractures crossing the wellbore. Herein “washouts” and “caves” will be used synonymously, i.e., to be different names for the same thing, to describe a wellbore enlargement in a plane transverse to the wellbore axis creating a local volume change. In some instances, washouts may occur at locations where fractures are not present, while in other cases washouts and fractures may occur at the same location.

For this invention, identification and characterization of fractures crossing the wellbore is of prime importance. FIG. 2B illustrates a wellbore 116 intersected by a fracture 214 at a dip indicated by a and an azimuth indicated by 0. The fracture 214 intersects the wellbore 116 along a trajectory 212. If an image of the wellbore wall is “unrolled” and displayed in a planar manner, such as displayed in FIG. 2C, then the intersection trajectory 212 appears as a sinusoid.

Typically, a wellbore imaging tool, particularly one using pad-based measurements in its design, will only image azimuthal sectors of the wellbore wall, such as azimuthal sectors 220a-d. Sinusoidal portions 222a-d of the sinusoidal pattern 212 indicating the fracture may be identified where it crosses the azimuthal sectors (see U.S. Pat. No. 5,243,521 for more information). The fracture's axial or depth location, dip angle, α, and azimuth, θ, are determined by analysis of the sinusoidal pattern identified on the wellbore wall image 224.

FIG. 2D shows an actual wellbore imaging result 216 of fractures crossing a wellbore. The imaging result 216 may be analyzed to produce an interpretation 218 of the patterns crossing the wellbore identifying fractures with their location, dip, and azimuth.

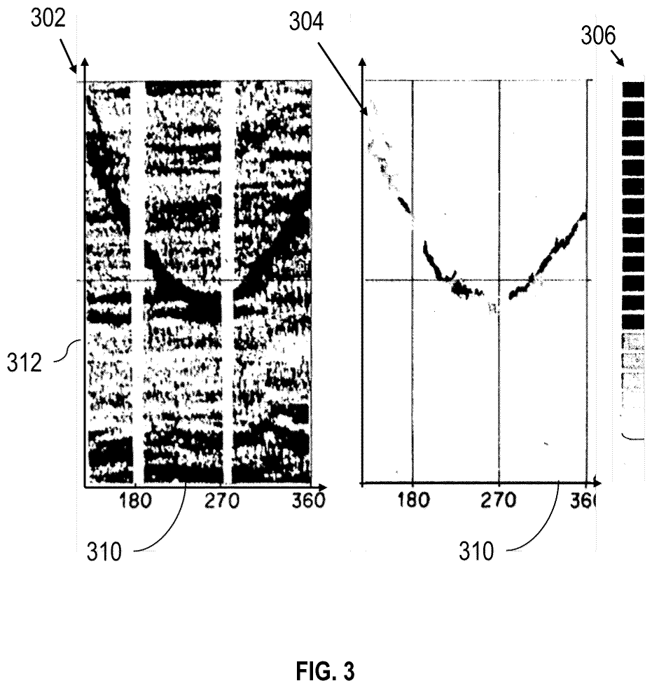

For electrical wellbore wall imaging, an additional process can be invoked to estimate the aperture of the fracture as a function of fracture location around the wellbore using measured additional current injected into the fracture for each location of the fracture around the wellbore (see U.S. Pat. No. 5,243,521 for more information). Depicted in FIG. 3 is a single fracture 302 characterized by an unambiguous sinusoidal trajectory or pattern around the wellbore. 304 is the result of the determination of the fracture aperture for each location of the fracture around the wellbore using these data. These results are plotted as a function of azimuth, indicated in degrees on the horizontal axis 310, and wellbore depth, indicated on the vertical axis 312. Hydraulic fracture apertures between 4/10,000 inches (0.01 mm) and 4/100 inches (1.0 mm) were obtained, varying strongly along the trace of the fracture. The fracture aperture grayscale 306, shows the highest aperture with the darkest shade at 4/100 inches (1.0 mm) and the lightest shade lowest at 4/10,000 inches (0.01 mm). Such aperture variations are not uncommon in natural fractures. And so, analysis of electrical wellbore images can deliver locations of fractures and their dip and azimuth, as well as estimation of fracture aperture across the scanned fracture openings. For some situations the end user, for example a geologist, may desire a single effective fracture aperture estimation for each depth in the wellbore. This estimate might be determined, for example, by a simple average of the fracture aperture determined around the wellbore. Other methods to arrive at an equivalent single aperture result for each identified fracture can be applied here as well. A limitation of electrical wellbore scan derived fracture aperture determination is that measurements are at the wellbore wall and analysis cannot differentiate between conductive fractures connected beyond the wellbore and non-conductive fractures terminating near the wellbore.

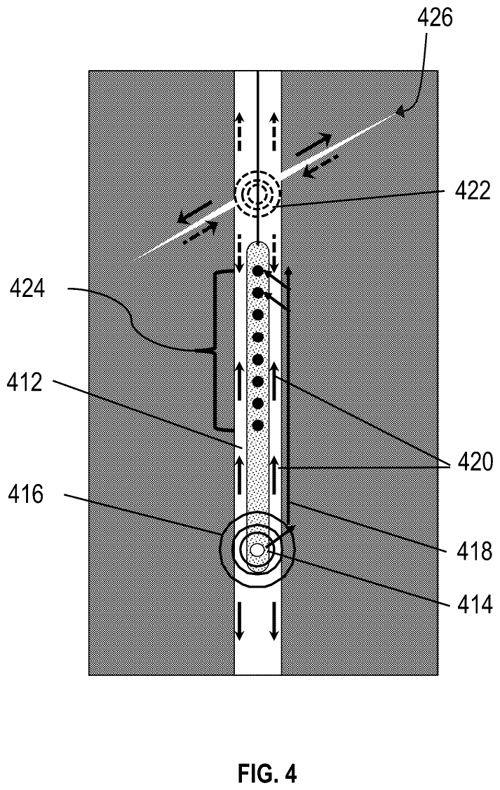

To complement the wellbore wall scan fracture analysis and determine what wellbore wall imaged fractures are conductive and so extend some distance beyond the wellbore Stoneley wave data generated and acquired by a wellbore sonic tool are used for deep investigation away from the wellbore. FIG. 4 illustrates a wellbore sonic tool 412. The wellbore sonic tool 412 may include a monopole source 414 that, when activated, may radiate omni-directional sonic waves 416 through the fluid filling the wellbore. The monopole source 414 may be typically used at high frequencies (greater than 6 kHz) to generate monopole compressional wave signals 418 that refract along the wellbore wall and are commonly used to estimate formation compressional wave slowness and/or velocity (slowness is defined as the reciprocal of velocity). These data are typically generated by a wide-band source drive and then filtered to the optimal band for processing.

In addition, Stoneley wave data 420 can be generated by a monopole source. Stoneley waves are most easily excited and have their highest amplitude at low frequencies and so common practice for acquisition of Stoneley waves is to use a source drive function focused on the low frequency part of the spectrum to deliver strong energy below the 4 KHz frequency range to as low a frequency as possibly, including frequencies below 500 Hz where possible. This source drive function is typically referred to as a “low frequency source drive”. Actual target frequencies for any special drive function are of course decided by the practitioner or tool operator and this can include any band deemed suitable. The Stoneley wave is a fundamental wellbore mode that is trapped in the wellbore and a large percentage (approximately 90%) of the wellbore sonic source energy is carried by the Stoneley wave. The Stoneley wave is entirely confined to the wellbore and may be considered as a pressure wave that travels up the wellbore. Thus, in essence the Stoneley wave data may be considered to “pressure test” the fractures as identified by the wellbore wall imaging scan analysis and the processing of the Stoneley data may also provide an estimate of hydraulic fracture aperture. As depicted in FIG. 4, the Stoneley wave is first received by an array of pressure sensitive sensors 424 located on the sonic tool some distance from the source. Next the Stoneley wave encounters a conductive fracture 426. At that point the Stoneley wave pressure is injected into the conductive fracture 426 that will result in the generation of a secondary signal 422 from the location of the conductive fracture 426 back into the wellbore. In essence the Stoneley “pressure pulse” pressurizes the fracture and a secondary response goes back to the wellbore as a reaction. A portion of the signal 422 propagates back down the wellbore and may be detected by receiver array 424. For fractures that propagate a large distance away from the well the magnitude of this signal is directly related to the aperture of the fracture. Here for conductive fractures “a large distance” can be up to 70 m or so when the wellbore contains low viscosity fluid, such as low viscosity drilling mud and a smaller distance for more viscous drilling mud. For fractures terminating a short distance from the well a very low amplitude secondary signal will be received from the fracture and so Stoneley wave analysis will indicate the fracture at that location to be non-conductive. More details can be found in U.S. Pat. No. 6,192,316 B1 (“Hornby-316”).

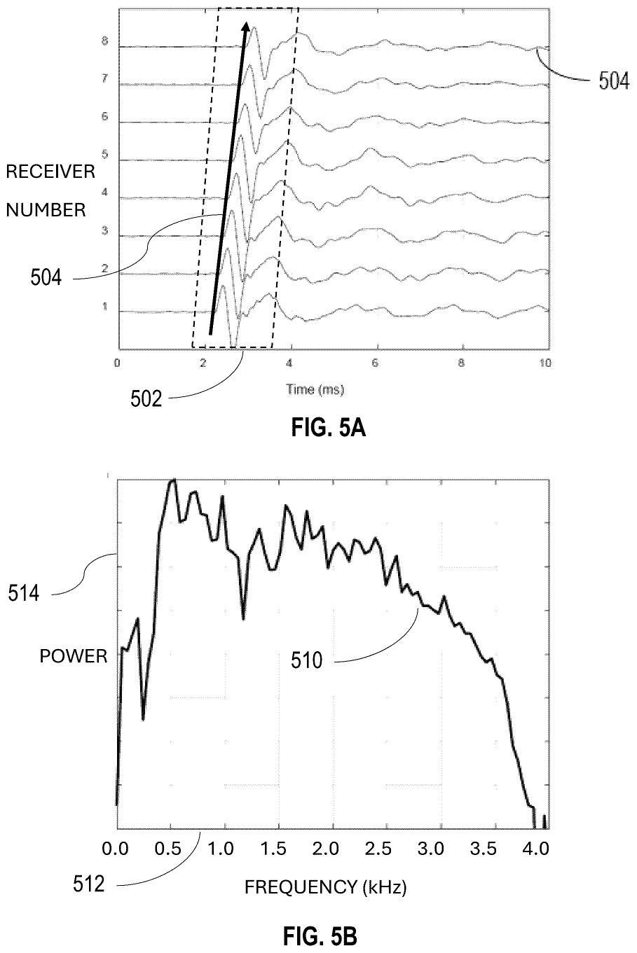

FIG. 5A illustrates raw full-waveform sonic data measured with a wellbore sonic logging tool 412 that includes a receiver array 424 containing eight axially spaced receivers. The time-series recorded by each receiver is indicated by a waveform, such as waveform 504. Source and receivers are configured for monopole acquisition and so strong, low-frequency, Stoneley wave arrivals 502 are readily apparent on the data set. The waveforms shown in FIG. 5A clearly show the direct arrivals and they arrive later in time from receiver to receiver as the Stoneley wave arrival 502 passes each receiver and as indicated by moveout 504. These direct Stoneley wave arrivals are essentially a pressure pulse 420 that moves along the wellbore as shown in FIG. 4. Secondary arrivals 422 from a fracture may be apparent later in time in this wave train but may be difficult to see for any given depth level on this sort of display without further sonic processing.

FIG. 5B illustrates a spectrum 510 of a single waveform obtained from spectral analysis. Frequency is indicated on the horizontal axis 512 and power on the vertical axis 514. It is clear that high power values are present at least as low as 400 Hz.

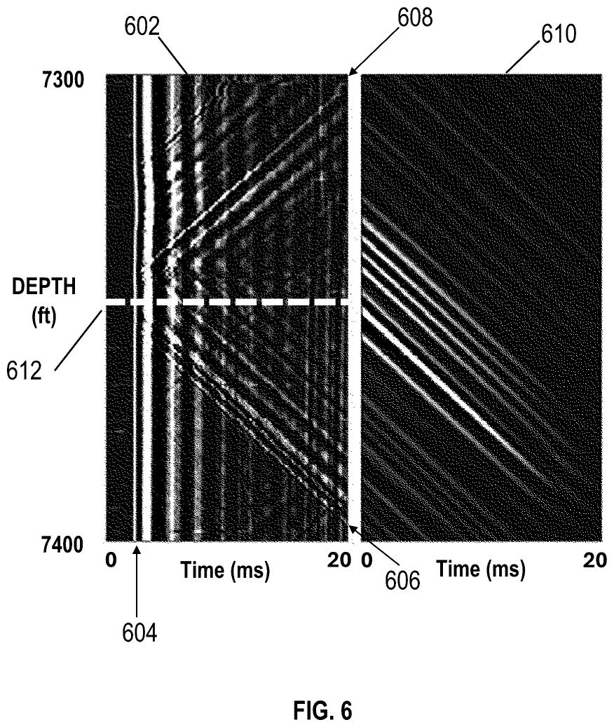

FIG. 6 shows a different way of looking at the data. Raw data 602 are displayed for a single receiver as a function of depth. This sort of display is commonly referred to as an “iso-offset” display as the data are displayed for a single source-receiver pair, at an unchanging distance or offset from one another, as a function of tool depth within the wellbore. The displayed depth may be receiver depth, source depth, the midpoint depth of the source receiver pair, or the depth of any other reference point on the sonic tool, without departing from the scope of the invention. Here the signals 604 near the first arrival of the data are seen to arrive at a near constant time. The signals are the Stoneley wave, and their essentially constant arrival time indicate the formation slowness changes little along the wellbore section displayed. Note that the Stoneley wave is a trapped wellbore mode and so its arrival time and slowness is strongly affected by the slowness of the drilling fluid. Here “slowness” is simply the inverse of velocity and is commonly used for wellbore measurements. As we can normally treat the drilling fluid slowness to be nearly constant as a function of depth, then little change in the Stoneley wave arrival time is commonly seen for this sort of display of single receiver data. Also, quite apparent on raw data 602 are downgoing reflected Stoneley waves that are manifested as oblique arriving signals 606 and upgoing oblique arriving signals 608. These arrivals will arrive at a time determined by the slowness of the Stoneley wave and the distance of the source-receiver pair from the fracture. These oblique arrivals are the reflected Stoneley wave response from the fracture. And so, when the source-receiver pair is below the fracture location 612 and the sonic tool proceeds up the well, the arrival time of the reflected signal decreases as the sonic tool approaches the fracture, and when the source-receiver pair is above the fracture the arrival time of the reflected signal increases as the sonic tool proceeds up the well away from the fracture.

The full waveform sonic data may be processed to separate the direct and reflected arrivals, in particular the direct and reflected Stoneley waves. This process may use an enhancement of the direct arrivals using a median filter, for example, and then the reflected signal may be extracted by simply subtracting the estimated direct arrivals from the raw data 602. Other enhancement processes may be applied as well as or instead of median filtering as long as an effective separation of the direct and reflected arrivals may be achieved. Finally, the extracted direct and reflected data may be combined to estimate a reflectivity as a function of frequency. Quite simply the basic expression for this process is this expression:

$$\overline{r} ( f ) = \frac{R ( f )}{D ( f )}$$

where f is frequency, R(f) is Stoneley wave reflection response, D(f) is the Stoneley wave direct response and r̅(f) is the reflection coefficient, or ratio of direct to reflected arrivals, all as a function of frequency. Note this expression for the reflectivity may be modified, supplemented, or extended deliver, for example to produce a more robust response and avoid issues like dividing by zero, without departing from the scope of the invention. For example, alternative expressions for reflectivity are shown in Hornby et al. 1989, “Fracture evaluation using reflected Stoneley-wave arrivals”, Geophysics, Vol. 54, No. 10 (October 1989), pp. 1274-1288 (“Hornby 1989”). The second column shows the results of applying this process to the direct 604 and downgoing 606 reflected Stoneley wave data. This result can be simply considered as the Stonely wave reflectivity response as a function of time. A Stoneley wave reflectivity response may be excited by fractures, or from wellbore features such as washouts or caves. Extracting a reflectivity curve as a function of depth may simply involve extracting the signal close to the wellbore, or a more complex algorithm can be applied. Although this procedure is illustrated for downgoing Stoneley wave reflection data 606 the same procedure can also be applied to upgoing Stoneley wave reflection data 608, and the average of the extracted reflectivity data averaged, for example, to achieve a robust result.

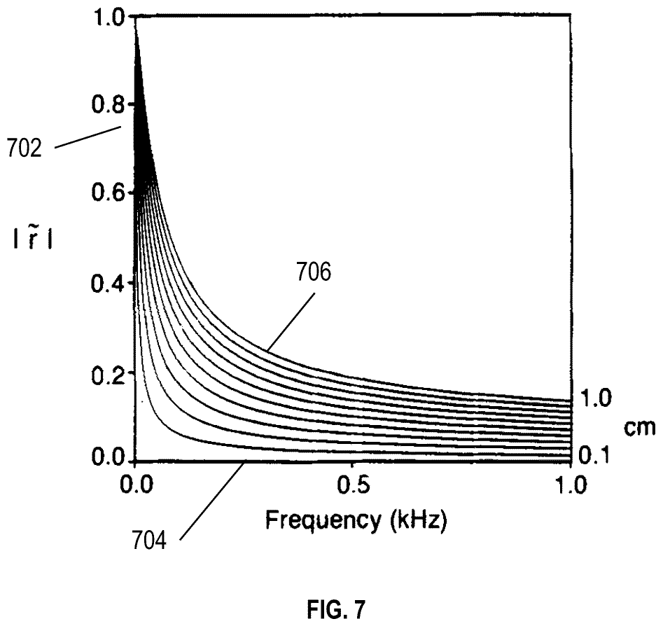

FIG. 7 shows modeled Stoneley wave reflectivity, or reflection coefficient as a function of frequency, curves as a function of frequency for hydraulic fracture apertures varying from 0.04 inches (0.1 cm) to 0.4 inches (1.0 cm), assuming a parallel plate model. The modulus of the reflectivity is indicated on the vertical axis 702 and frequency on the horizontal axis 704. Each curve, e.g., curve 706, indicates the reflectivity for one hydraulic aperture. Two things are clear in this picture, first, Stoneley wave reflectivity is sensitive to variations in hydraulic fracture aperture, and second, Stoneley wave reflectivity response is seen to increase exponentially as frequency drops below 0.5 kHz or so. Note, at 0 frequency the “static limit” is seen, where fluid will simply flow from the wellbore into the fractures and the region appears like a pressure release boundary with 100% of the incident Stoneley reflected. More details can be found in Hornby-316 and Hornby 1989.

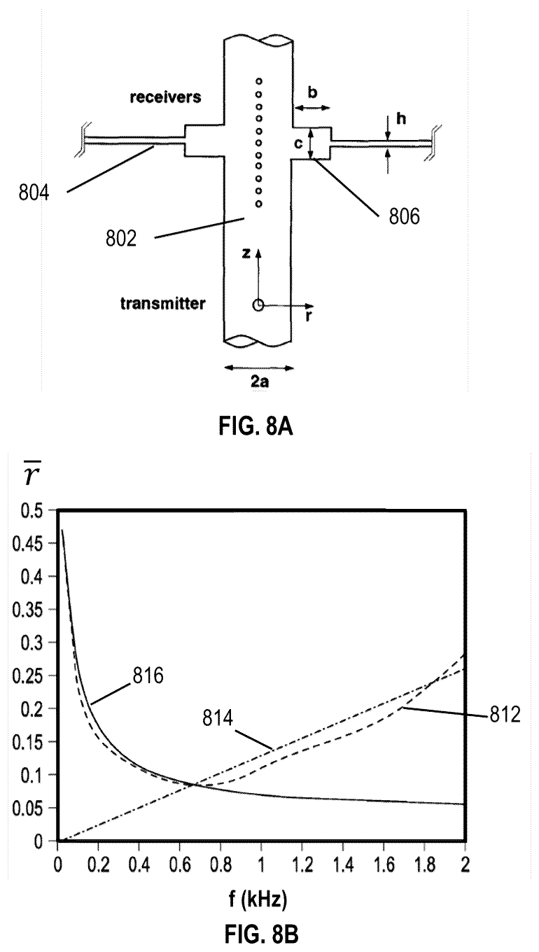

To understand the relative effect of wellbore features such as washouts or caves on Stoneley wave reflectivity FIG. 8A shows a model of a wellbore 802 where the region where the fracture 804 intersects the wellbore is enlarged. The shape of the enlarged region 806, henceforth referred to generically as a “washout”, is arbitrary and here has a length “b” of 6 cm, an aperture “c” of 4 cm, and a wellbore radius “a” of 10 cm. Hydraulic fracture aperture “h” is 0.5 cm. FIG. 8B displays modeled Stoneley wave reflectivity response for these three situations. Stoneley wave reflectivity as a function of frequency is displayed for three models. Dashed line 812 shows the modeled reflectivity spectrum for a washout 806 and a fracture 804; dashed-dot line 814 is for the case of a washout 806 only, and solid line 816 is the response of a single fracture 804 only. As evident from FIG. 8B, the frequency behavior 816 of a fracture, such as fracture 804, indicates high reflectivity at low frequencies and low reflectivity at high frequencies while the frequency behavior 816 of a washout 806 indicates a low reflectivity at low frequencies and high reflectivity at high frequencies. Finally, a combined washout 806 at a fracture location 804 exhibits high reflectivity at both low and high frequencies (with the fracture providing the low frequency contribution while the washout provides high frequency contribution). As can be seen with this analysis, acquisition of Stoneley wave data at as low a frequency as possible is important to achieve good results and eliminate or reduce any interference from wellbore washouts. In this example it can be seen that if useful data were recorded at below 600 Hz then selecting a frequency range to the limit of the acquired low frequency range might be used to deliver a robust estimate for fracture aperture even when the fracture is at a washout location. Note that although low frequency processing provides the best estimate of fracture apertures additional processing of Stoneley wave data to high frequencies can provide an additional quality control that will aid interpretation of the results. For example, if the highest reflectivity response is at high frequencies and only a low response is seen at low frequencies, then the response can be interpreted as either from a washout alone or a washout with a low conductivity fracture. More details can be found in Kostek, et al., “The interaction of tube waves with wellbore fractures, Part I: Numerical models”, Geophysics, Vol. 63, No. 3 (May-June 1998), pp. 800-808, and to Kostek, et al., “The interaction of tube waves with wellbore fractures, Part II: Analytical models”, Geophysics, Vol. 63, No. 3 (May-June 1998), pp. 809-815.

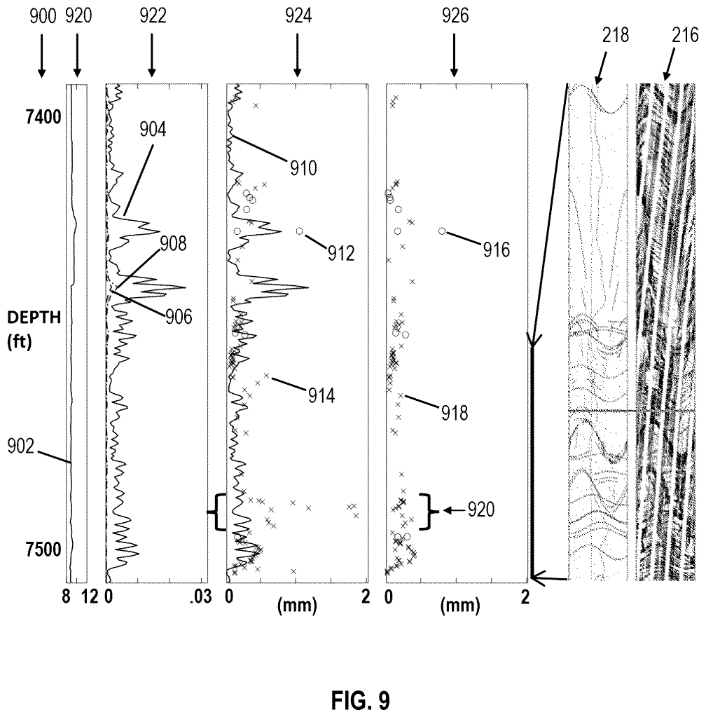

FIG. 9 shows measured hole diameter with computed results for Stoneley wave reflectivity and hydraulic fracture aperture estimations determined by both electrical wellbore scans and Stoneley wave inversion as a function of depth, indicated on the vertical axis 900. Panel 920 shows hole diameter 902 which largely reflects the drilling bit size of 9 inches, however there are excursions to larger diameters around 7420 to 7440 ft wellbore depth. Stoneley wave reflectivity is shown in panel 922 and is processed and plotted for several frequencies. Low frequency, i.e., 500 Hz results 904, show large excursions likely indicating fractures, while high frequency results, i.e., 2000 Hz results 906 and 3000 Hz results 908 both come in at low reflectivity levels, indicating that results are likely not affected by wellbore washouts, such as washout 806. The largest wellbore enlargement is located around 7440 ft wellbore depth with a washout depth around 3 cm which is somewhat smaller than model results shown in FIG. 8B where the washout depth was 6 cm. Consistent with FIG. 8B modeling result and the low level of high frequency reflectivity at that depth, the washout is seen to have little effect on the 500 Hz Stoneley wave reflectivity result. This conclusion also follows at the smaller washout indicated at around 7425 ft.

Hydraulic fracture aperture estimations for both electrical wellbore imaging and Stoneley wave analyses are shown in panel 924. Stoneley wave hydraulic fracture aperture 910 is estimated using a mathematical relationship between effective hydraulic fracture aperture, wellbore diameter, and frequency as used to compute results shown in FIGS. 7 and 8B. This procedure uses the measured hole diameter at each depth and so will largely compensate for washouts connected to a fracture. More details can be found in Hornby-316 and Hornby 1989. Note, the estimated Stoneley wave hydraulic fracture aperture is estimated at each depth and so delivers a continuous curve. Fracture location may now be accounted for. Wellbore imaging result 216 shows scanned fractures and other features crossing the wellbore. Interpretation 218 of the patterns crossing the wellbore then identify fractures with their direction and angle. The results may be separated into drilling induced fractures and natural fractures, as determined by the analyst interpreting the wellbore image scan. Using the previously determined method electrical wellbore wall imaging effective hydraulic fracture aperture determinations are then computed and displayed for the individual fracture depths as determined by the analyst interpreting the wellbore image scan. In panel 924 the effective electrical wellbore imaging hydraulic fracture apertures determined for drilling induced fractures are indicated by a circle symbol, such as circle symbol 912 and the effective electrical wellbore imaging hydraulic fracture apertures determined for natural fractures are indicated by a x-symbol, such as x-symbol 914.

Panel 926 shows the result of a process to estimate a more accurate aggregate hydraulic fracture aperture using a combination of Stoneley wave and electrical wellbore imaging hydraulic fracture aperture estimations. Here for each determined fracture location Stoneley wave determined hydraulic fracture aperture is compared to the electrical wellbore wall imaging hydraulic fracture aperture at that depth. If the two estimations are within a pre-determined percentage of each other, then the average of both estimations are taken as the hydraulic fracture aperture. The percentage value is chosen by the analyst and for this example it is chosen to be 20%. Here of course the analyst is not limited and can choose any percentage difference desired. At each identified fracture depth, if the difference of the two estimations is more than this pre-determined percentage then the lower of the two hydraulic fracture estimations is taken as the hydraulic fracture aperture. The rationale behind choosing the lowest of the two hydraulic fracture estimations is that, for both the Stoneley wave and electrical wellbore scan hydraulic fracture estimations any error in estimation of the hydraulic fracture aperture normally causes the estimated hydraulic fracture aperture to be a larger value. For example, if the fracture opening is enlarged or connected to a washout as shown in FIG. 8A the electrical wellbore imaging hydraulic fracture determined aperture may be significantly larger than the true hydraulic fracture aperture at that depth. In that case if the Stoneley wave determined fracture aperture is a lower aperture than the Stoneley wave determined aperture is taken as the estimated hydraulic fracture aperture at that depth. The other case is if the Stoneley wave estimated hydraulic fracture width is larger than the electrical wellbore imaging hydraulic fracture determined aperture. In that case, the electrical wellbore imaging hydraulic fracture aperture estimation is chosen as the hydraulic fracture aperture for that depth. That could happen if a strong bed boundary is close to the identified fracture depth for example. The result of this process is shown in panel 926 for 918 natural fractures and 916 drilling induced fractures. 920 shows a depth interval where in panel 924 electrical wellbore imaging hydraulic fracture estimations 914 are significantly larger than the 910 Stoneley wave hydraulic fracture estimations for the same depths. For that interval the electrical wellbore imaging hydraulic fracture estimations are likely affected by enlarged fracture opening at the wellbore wall and so the Stoneley wave hydraulic fracture aperture estimation is used. Overall, the aggregate hydraulic fracture aperture evaluation shown in panel 926 has much less scatter than the separate results in panel 924 and should deliver much more accurate results using the combined information.

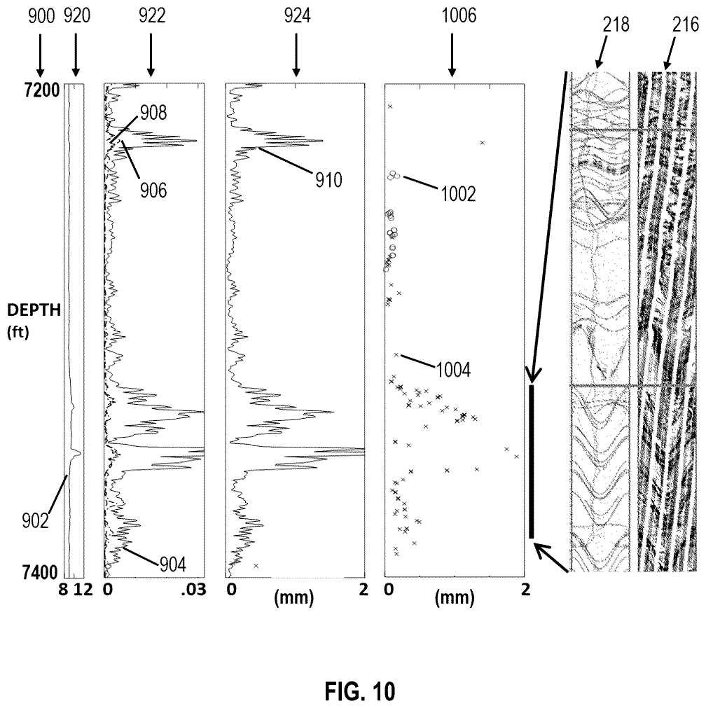

FIG. 10 shows the case where there is determination of fracture depth locations and basic fracture property determinations of dip and azimuth but there are no electrical wellbore imaging fracture aperture estimations for these depths. For this case the Stoneley wave hydraulic fracture estimate is integrated with the wellbore imaging determined fracture depth location and dip and azimuth analysis to deliver fracture depth, dip, azimuth and hydraulic fracture aperture at every fracture location. In FIG. 10 hole diameter 902 largely reflects the drilling bit size of 9 inches, however there are excursions to larger diameters around 7350 and 7530 ft wellbore depth. Stoneley wave reflectivity may be processed and displayed for several frequencies. Low frequency, i.e., 500 Hz, results 904 show large excursions likely indicating fractures. High frequency results, 2000 Hz 906 and 3000 Hz 908, both show low reflectivity levels, indicating that results are likely not affected by wellbore washouts. The largest wellbore enlargement is located around 7350 ft wellbore depth with a washout depth around 4 cm which is somewhat smaller than model results shown in FIG. 8B where the washout depth was 6 cm. Consistent with FIG. 8B model result and the low level of high frequency reflectivity at that depth the washout is seen to have little effect on the 500 Hz Stoneley wave reflectivity result. This conclusion also follows at the smaller washout indicated at around 7330 ft. Panel 1006 shows locations of drilling induced 1002 and natural hydraulic fractures 1004, with the Stoneley wave estimated hydraulic fracture aperture for each fracture for this section of the wellbore. As we have determined that the Stoneley wave reflectivity result is little affected by any wellbore washouts these estimated hydraulic fracture apertures are deemed to be of high quality.

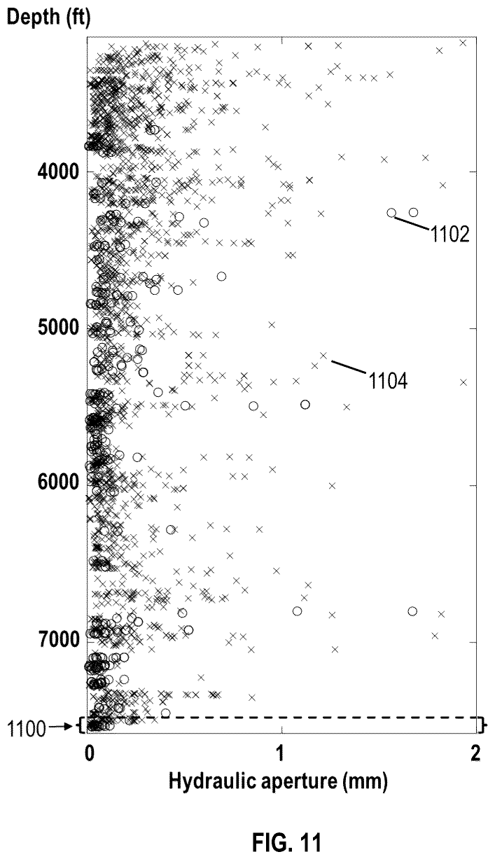

FIG. 11 shows locations of drilling induced 1002 and natural hydraulic fractures 1004, indicated on the vertical axis, with the aggregate hydraulic fracture aperture where available and otherwise with the Stoneley wave estimated hydraulic fracture aperture for each fracture, indicated on the horizontal axis, for the entire logged section of the wellbore. FIG. 11 displays the results for thousands of fractures across the whole open hole section of the wellbore at the locations determined by analyst examination of the electrical wellbore scan. 1100 highlights the section of the wellbore where electrical wellbore wall imaging fracture aperture estimations are available with the Stoneley wave analysis and aggregate hydraulic fracture aperture is computed. This section is small, 120 ft in depth range, and has little effect on the overall hydraulic fracture aperture result throughout the well. However, the results as shown in FIG. 9 show an excellent match between fracture aperture using electrical wellbore scans and Stoneley wave analysis which supports the stand alone Stoneley hydraulic fracture determination being of reasonable accuracy throughout the large well section. Not shown on this plot but also included in the results is fracture dip and azimuth for each location. These quantitative results are key inputs to 3D discrete fracture network (DFN) modeling efforts.

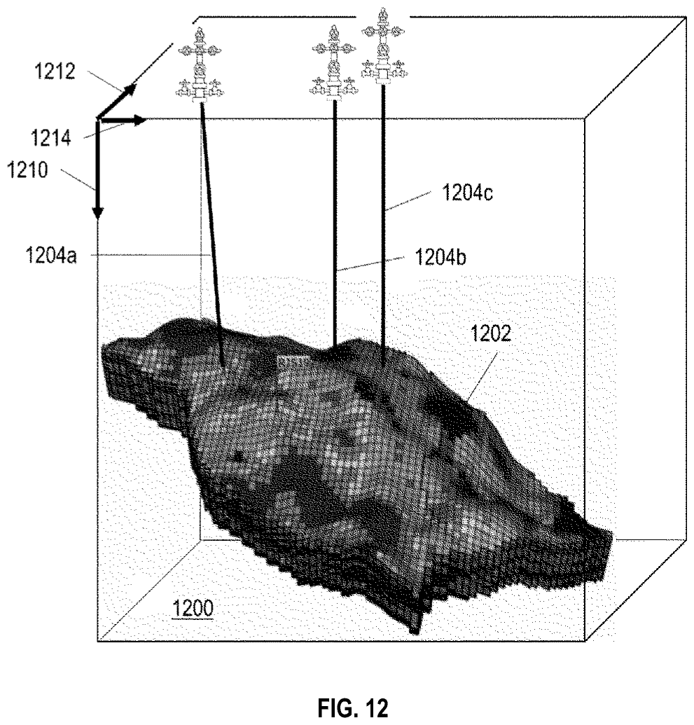

FIG. 12 depicts a complex reservoir simulation model 1202 penetrated by several wells 1204a-c. FIG. 12 shows the reservoir model 1202 embedded within subsurface region 1200 displayed using a depth axis 1210 and two orthogonal horizontal axes 1212, 1214. A reservoir simulation model, such as reservoir simulation model 1202, may describe rock and fluid properties as a function of position throughout the subterranean reservoir. For example, the reservoir simulation model may describe the porosity, permeability, and/or wettability of the rock, and the pressure, temperature, viscosity, chemical composition, type, and phase, i.e., water, oil or gas, of the fluid. The reservoir model may be discretized using a grid of many cells each describing a small volume of the reservoir. Typically, a reservoir simulation model, such as model 1202, may include several million grid cells. In some embodiments, the reservoir simulation model may use a cartesian grid, but in other embodiments the grid may contain non-cartesian grids, including irregular grids containing cells of many different shapes and sizes.

The reservoir simulation model may be used to simulate the flow or percolation of fluids, such as oil, gas, and water, through the reservoir as a function of production time, i.e., the time from the initial drilling of production wellbores and the extraction of fluids from the reservoir. The reservoir simulation results may be used to predict future fluid production, including total cumulative future production under various potential scenarios. For example, the result of drilling additional production wells, and/or of drilling additional future injection wells (water may be injected around the periphery of hydrocarbon reservoirs to maintain pressure and sweep or flush oil and gas towards production wells). The results of reservoir simulation models may be used in selecting preferred locations, trajectories and types of wellbore, and of selecting preferred completions. For example, reservoir simulation results may be used to determine the type and location of pumps to suck oil and gas to the surface, and the preferred location of holes (perforations) in casing, pipes, and tubing inserted into existing and future wellbores to allow desired fluids, such as oil and gas, to flow through the pipes and tubing to the surface, and to minimize the inflow of undesirable fluids, such as brine and water.

Typically, reservoir simulation requires the iterative solution to complicated mathematical equations encapsulating the physical laws governing fluid flow or percolation through the reservoir for each of a plurality of time steps representing the production history and production future of the reservoir. For example, these laws may include Darcy's law, and Equations of State governing the changes in phase and viscosity of fluids under the influence of changing pressure and temperature. Solving these equations for each of the typically several million grid cells from which the reservoir simulation model is composed is obviously far beyond any manual or mental process, even assisted by hand, mechanical, or electronic calculator. Instead, reservoir simulators, including large computation systems configured with dedicated software created to solve the equations outlined above are required to perform the reservoir simulation. Typically, such reservoir simulators will further include many thousands of computer processors, and/or graphical processing units (“GPUs”) and connected to visual display units configured to display the results of the simulations in intuitively meaningful ways.

In reservoirs characterized by significant fracturing, the hydraulic aperture of the fractures may contribute significantly to the overall or composite permeability and porosity of the reservoir. In these cases, it may be extremely helpful to have at least a statistically accurate representation of the distribution of fractures throughout the reservoir and to include this information within the reservoir simulation model. A discrete fracture network may be used for this purpose, i.e., to provide an estimation of the fracture distribution as part of the overall reservoir model.

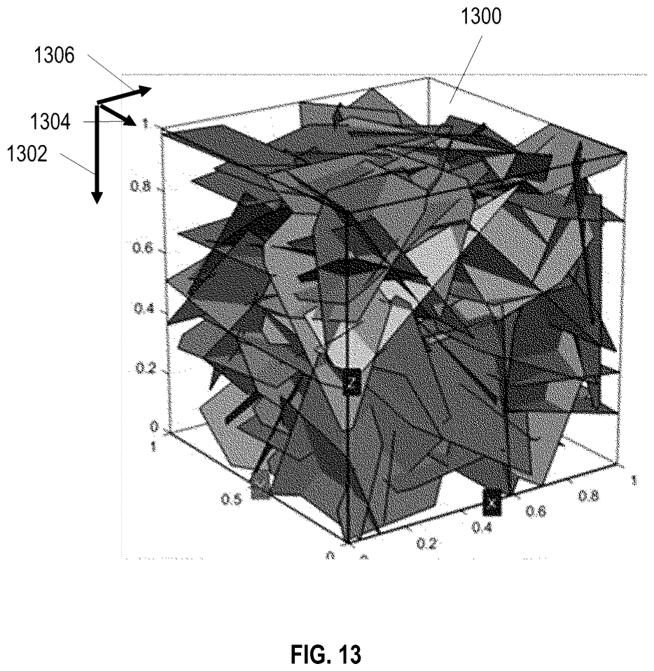

FIG. 13 depicts an example 3D DFN 1300 for a portion of the subsurface depicted along three orthogonal spatial coordinates, 1302, 1304, 1306, whose characteristics may be integrated into the overall reservoir model 1202. DFN modeling requires estimated or measured properties of hydraulic fracture aperture and fracture location, dip and azimuth for wells penetrating the reservoir. High-quality estimates of these properties, as provided by this invention, can greatly improve the accuracy of reservoir simulation over previous methods. For example, from the measured values of hydraulic aperture, dip and azimuth obtained from wellbores penetrating the hydrocarbon reservoir, statistical models quantitatively describing the frequency with which fractures are present within the reservoir, their average hydraulic aperture, and orientation (dip and azimuth) may be created. In some embodiments, this statistical information may be incorporated directly in the reservoir simulation model, while in other embodiments, one or more realizations of the DFN may be generated from the statistical models, and these DFN realizations included in the reservoir simulation model.

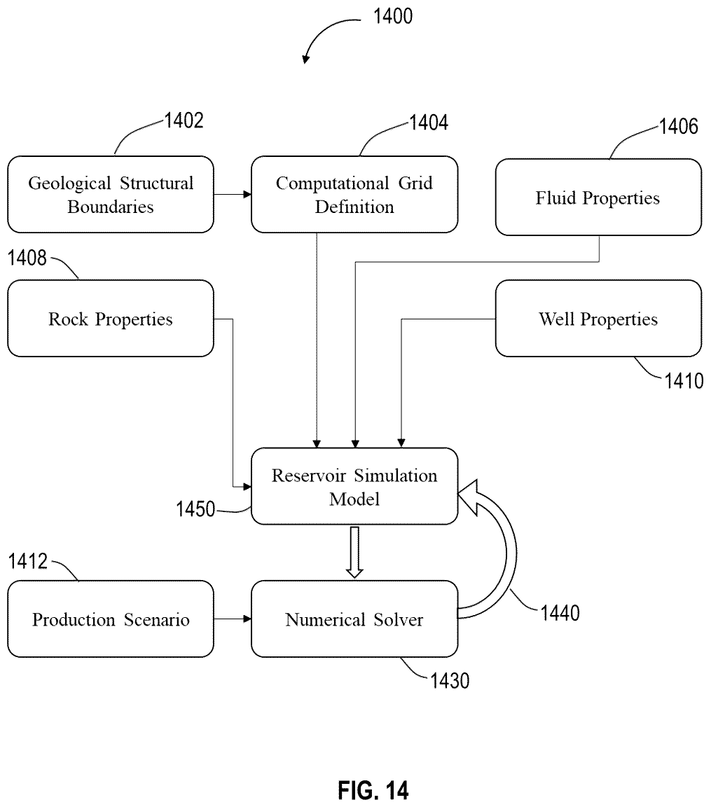

FIG. 14 depicts a flowchart 1400 for creating a reservoir simulation model 1450 and performing reservoir simulation in one or more embodiments. In a first step geological structural boundaries 1402 may be defined. The geological structural boundaries may be based upon the interpretation of seismic images, and upon observations from well logs or drill cuttings made in wellbores penetrating the reservoir. The geological structural boundaries may include an upper surface, a lower surface, geological faults and intra-reservoir layering. A computational grid 1404 may be determined based upon the structural boundaries. The computation grid 1404 may be regular, such as a cartesian grid, or irregular, and may conform to the upper and lower surfaces of the reservoir.

Fluid properties and equations of state for the fluids 1406 for the fluids present in the reservoir may be supplied. The fluid properties may be determined from fluid samples taken from exploration and appraisal wellbore drilled into the reservoir or estimated from analogous reservoirs nearby. The equations of state, for example controlling the change variation of volume with changing pressure and temperature and or the change of viscosity and phase (e.g., from oil to gas or vice versa), may be determined from laboratory studies on the fluid samples collected.

Rock properties and discrete fracture networks 1408 are required input for the reservoir simulation model 1450. Rock properties may include, without limitation, porosity, permeability, and wettability of the rocks, each of which may be determined using laboratory analysis of core samples obtained during or after drilling of wellbore penetrating the reservoir and/or from well log measurements recorded during drilling, using logging-while-drilling logging tools, or after drilling using wireline or coiled tubing conveyed logging tools. The discrete fracture networks may be determined using the methods disclosed herein, for example as described in connection with FIG. 13.

Well properties 1410, such as well location, trajectory, caliper (diameter) completion type, and bottomhole pressure may be supplied for currently existing wellbores may be provided to the reservoir simulation model 1450.

Reservoir simulation may be performed using the reservoir simulation model. Reservoir simulation may involve the numerical solution 1430 of the equations describing the flow or percolation of the reservoir fluids through the reservoir. The numerical solution may involve determining parameters of the reservoir, such as fluid pressures within the reservoir, at a second time, from the fluid pressures at an earlier first time, followed by the determining parameters at a third time from the values at the second time, and so on for a series of times representing the production life of the reservoir. For example, the times of the series of times may be separated by an interval of several days, or several weeks, and the production life of the reservoir may be several years to several decades. Thus, an iterative or recursive loop 1440 may be used to repeatedly update the fluid distribution or properties within the reservoir model.

Reservoir simulation may be used for at least one of two purposes. Firstly, the past history of the behavior of the reservoir may be simulated in a process known as (production) “history matching”. Secondly, the future behavior of the reservoir may be simulated.

In history matching, the past behavior of the reservoir is simulated at a series of times over its production history and compared against observed behavior. For example, the observed volume of fluids produced by each well over time may be imposed as a boundary condition, and the bottomhole pressure of each wellbore may be simulated. The predicted bottomhole pressure may then be compared against the observed bottomhole pressures for each time in the history and the parameters of the reservoir model 1450 may be adjusted to improve the match between the observed history of bottomhole pressures and the predicted history of values. For example, the permeability may be increase slightly in one portion of the reservoir simulation model, and/or decreased slightly in another portion. The result of this process of history matching may be a more accurate reservoir simulation model.

Secondly, reservoir simulation may be used to predict the future behavior of fluids within the reservoir, including the rates and total volume of fluids that may be produced from the reservoir under various production scenarios 1412. To predict the future behavior one or more production scenarios must be provided. The scenarios may describe actions upon the reservoir performed by the operator, such as the drilling of additional wellbores, the installation of surface or downhole pumps, and/or the injection of water around the periphery of the reservoir to maintain the reservoir pressure and sweep or flush oil and gas towards production wells.

To obtain accurate results for any of the above stated purposes an accurate discrete fracture network including dip, azimuths and representative hydraulic fracture apertures may be required.

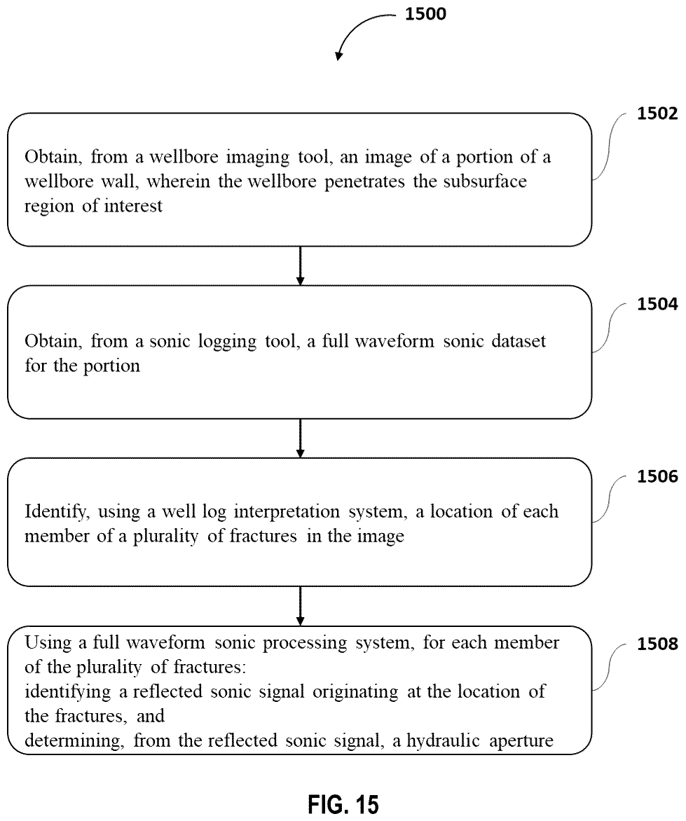

FIG. 15 depicts flowchart 1500 for determining a hydraulic fracture aperture within a subsurface region of interest, in accordance with one or more embodiments.

In Step 1502 an image of a portion of a wellbore wall may, in accordance with one or more embodiments, be obtained obtain for a wellbore penetrates the subsurface region of interest. The image may be obtained using a wellbore imaging tool. In some embodiments, the wellbore image may be an electrical conductivity image or an electrical resistivity image. In other embodiments, the wellbore image may be an ultrasonic image, while in still other embodiments, the wellbore image may be an optimal image or a televiewer image.

In accordance with one or more embodiments, in Step 1504, a full waveform sonic dataset may be obtained for the portion of the wellbore. The full waveform sonic dataset may be obtained using a sonic logging tool. In some embodiments, the full waveform sonic dataset may include a Stoneley dataset. Typically, the Stoneley dataset may contain low frequency data. For example, the Stoneley dataset have a dominant frequency of less than 1 kilohertz, i.e., the largest spectral amplitude of the spectrum of the Stoneley dataset may occur at a frequency of less than 1 kilohertz.

In some embodiments, the sonic logging tool and the wellbore imaging tool may be conveyed (lowered or pushed) into the wellbore using a conveyance. The conveyance may be an electrical wireline, a slick wireline, an optical wireline, a drill pipe, a wired-drill pipe, a coiled tubing, an electrical wireline connected to a wellbore tractor, or any other method of conveyance known in the art without limiting the scope of the invention.

In Step 1506 a location of each member of a plurality of fractures in the image may be identified using a well log interpretation system. In addition, a dip and an azimuth for each member of a plurality of fractures in the image may be identified. In some embodiments, identifying the location of each member of a plurality of fractures, may include determining a meta-fracture (or “effective fracture”) from a set of fractures located within a depth interval of the wellbore. For example, the meta-fracture may be determined such that some or all of the characteristics, i.e., dip, azimuth, and hydraulic aperture, of the meta-fracture are equivalent to an average (mean, media, mode, or other appropriate average) or a sum of all the fractures within the depth interval. The depth interval may be related to the dominant wavelength of the full waveform sonic dataset. For example, in some embodiments the depth interval may have a length equal to the dominant wavelength, and in other embodiments the depth interval may have a length equal to half the dominant wavelength. The location of the meta-fracture may be assigned to be a point within the depth interval, such as, without limitation, the center of the depth interval to be the location.

In accordance with one or more embodiments, an aggregate hydraulic aperture may be determined based, at least in part, on the Stoneley reflection coefficient and an image aperture determined from the image. In some embodiments the aggregate hydraulic aperture may be a mean of the hydraulic aperture determined from the Stoneley reflection coefficient and the image aperture. In other embodiments, the image aperture may be disregarded if its value differs by more than a threshold amount from the hydraulic aperture determined from the Stoneley reflection coefficient. For example, if the image aperture is more than 25% greater or smaller than the hydraulic aperture determined from the Stoneley reflection coefficient the image aperture value may be disregarded. The threshold may, without limitation, be a predetermined value, or may be based upon the distribution or range of aperture differences observed within the current datasets, or may be selected on a trial and error basis by an engineer executing the disclosed process.

In accordance with one or more embodiments, in Step 1508, for each member of the plurality of fractures, a reflected sonic signal originating at the location of the fractures and a hydraulic aperture may be identified using a full waveform sonic processing system. In some embodiments, the hydraulic aperture may be determining a Stoneley wave reflection coefficient. The Stoneley wave reflection coefficient may be a scale value or may be a frequency dependent reflection coefficient spectrum with a value at each of a plurality of sample frequency values.

Furthermore, in some embodiments, a statistical characterization of a subsurface region surrounding the wellbore may be formed. The statistical characterization may include a dip distribution, an azimuth distribution, and a hydraulic aperture distribution, where the dip distribution is based, at least in part, on the dip of each member of the plurality of fractures, the azimuth distribution is based, at least in part, on the azimuth of each member of the plurality of fractures, and the hydraulic aperture distribution is based, at least in part, on the hydraulic aperture of each member of the plurality of fractures.

In some embodiments a discrete fracture network (DFN) model may be populated based, at least in part, on the statistical characterization. In some embodiments, a reservoir simulator may predict a hydrocarbon production rate based, at least in part, on the DFN model of the subterranean region.

Each of the well log interpretation system, the full waveform sonic processing system, and the reservoir simulator may include a computer system equipped with appropriate software configured to perform each specialized function, viz., well log interpretation, full waveform sonic processing, and reservoir simulation. In addition, the wellbore imaging tool and the sonic logging tool may each be communicatively connected with a computer system configured to communicate operating instructions and receive data from the corresponding tool. The software may be stored on non-transitory computer-readable memory in the form of computer-executable instructions stored thereon.

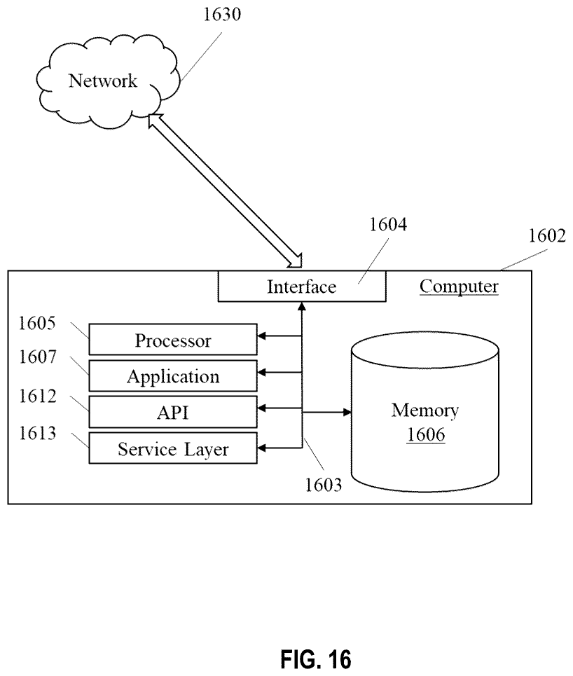

FIG. 16 depicts a block diagram of a computer system (hereinafter also “computer”) 1602 used to provide computational functionalities associated with described algorithms, methods, functions, processes, flows, and procedures as described in this disclosure, according to one or more embodiments. The illustrated computer 1602 is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer 1602 may include a computer that includes an input device, such as a keypad, keyboard, touch screen, or other device that can accept user information, and an output device that conveys information associated with the operation of the computer 1602, including digital data, visual, or audio information (or a combination of information), or a GUI.

The computer 1602 can serve in a role as a client, network component, a server, a database or other persistency, or any other component (or a combination of roles) of a computer system for performing the subject matter described in the instant disclosure. The illustrated computer 1602 is communicably coupled with a network 1630. In some implementations, one or more components of the computer 1602 may be configured to operate within environments, including cloud-computing-based, local, global, or other environment (or a combination of environments).

At a high level, the computer 1602 is an electronic computing device operable to receive, transmit, process, store, or manage data and information associated with the described subject matter. According to some implementations, the computer 1602 may also include or be communicably coupled with an application server, e-mail server, web server, caching server, streaming data server, business intelligence (BI) server, or other server (or a combination of servers).

The computer 1602 can receive requests over network 1630 from a client application (for example, executing on another computer 1602 and responding to the received requests by processing the said requests in an appropriate software application. In addition, requests may also be sent to the computer 1602 from internal users (for example, from a command console or by other appropriate access method), external or third-parties, other automated applications, as well as any other appropriate entities, individuals, systems, or computers.

Each of the components of the computer 1602 can communicate using a system bus 1603. In some implementations, any or all of the components of the computer 1602, both hardware or software (or a combination of hardware and software), may interface with each other or the interface 1604 (or a combination of both) over the system bus 1603 using an application programming interface (API) 1612 or a service layer 1613 (or a combination of the API 1612 and service layer 1613. The API 1612 may include specifications for routines, data structures, and object classes. The API 1612 may be either computer-language independent or dependent and refer to a complete interface, a single function, or even a set of APIs. The service layer 1613 provides software services to the computer 1602 or other components (whether or not illustrated) that are communicably coupled to the computer 1602. The functionality of the computer 1602 may be accessible for all service consumers using this service layer. Software services, such as those provided by the service layer 1613, provide reusable, defined business functionalities through a defined interface. For example, the interface may be software written in JAVA, C++, or other suitable language providing data in extensible markup language (XML) format or another suitable format. While illustrated as an integrated component of the computer 1602, alternative implementations may illustrate the API 1612 or the service layer 1613 as stand-alone components in relation to other components of the computer 1602 or other components (whether or not illustrated) that are communicably coupled to the computer 1602. Moreover, any or all parts of the API 1612 or the service layer 1613 may be implemented as child or sub-modules of another software module, enterprise application, or hardware module without departing from the scope of this disclosure.

The computer 1602 includes an interface 1604. Although illustrated as a single interface 1604 in FIG. 16, two or more interfaces 1604 may be used according to particular needs, desires, or particular implementations of the computer 1602. The interface 1604 is used by the computer 1602 for communicating with other systems in a distributed environment that are connected to the network 1630. Generally, the interface 1604 includes logic encoded in software or hardware (or a combination of software and hardware) and operable to communicate with the network 1630. More specifically, the interface 1604 may include software supporting one or more communication protocols, such as the Wellsite Information Transfer Specification (WITS) protocol, associated with communications such that the network 1630 or interface's hardware is operable to communicate physical signals within and outside of the illustrated computer 1602.

The computer 1602 includes at least one computer processor 1605. Although illustrated as a single computer processor 1605 in FIG. 16, two or more processors may be used according to particular needs, desires, or particular implementations of the computer 1602. Generally, the computer processor 1605 executes instructions and manipulates data to perform the operations of the computer 1602 and any algorithms, methods, functions, processes, flows, and procedures as described in the instant disclosure.

The computer 1602 also includes a memory 1606 that holds data for the computer 1602 or other components (or a combination of both) that can be connected to the network 1630. For example, memory 1606 can be a database storing data consistent with this disclosure. Although illustrated as a single memory 1606 in FIG. 16, two or more memories may be used according to particular needs, desires, or particular implementations of the computer 1602 and the described functionality. While memory 1606 is illustrated as an integral component of the computer 1602, in alternative implementations, memory 1606 can be external to the computer 1602.

The application 1607 is an algorithmic software engine providing functionality according to particular needs, desires, or particular implementations of the computer 1602, particularly with respect to functionality described in this disclosure. For example, application 1607 can serve as one or more components, modules, applications, etc. Further, although illustrated as a single application 1607, the application 1607 may be implemented as multiple applications 1607 on the computer 1602. In addition, although illustrated as integral to the computer 1602, in alternative implementations, the application 1607 can be external to the computer 1602.

There may be any number of computers 1602 associated with, or external to, a computer system containing a computer 1602, wherein each computer 1602 communicates over network 1630. Further, the term “client,” “user,” and other appropriate terminology may be used interchangeably as appropriate without departing from the scope of this disclosure. Moreover, this disclosure contemplates that many users may use one computer 1602, or that one user may use multiple computers 1602.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. Rather, the described features and steps are disclosed as possible components of systems and methods within the scope of the appended claims. Moreover, claim language reciting “at least one of” a set indicates that one or multiple members of the set satisfy the claim.

What is claimed:

1. A method for determining a hydraulic fracture aperture within a subsurface region of interest, comprising:
obtaining, from a wellbore imaging tool, an image of a portion of a wellbore wall, wherein the wellbore penetrates the subsurface region of interest;
obtaining, from a sonic logging tool, a full waveform sonic dataset for the portion;
identifying, using a well log interpretation system, a location of each member of a plurality of fractures in the image; and
using a full waveform sonic processing system, for each member of the plurality of fractures:
identifying a reflected sonic signal originating at the location of the fractures, and
determining, from the reflected sonic signal, a hydraulic aperture.

2. The method of claim 1, further comprising determining from the image a dip and an azimuth for each member of a plurality of fractures in the image.

3. The method of claim 2, further comprising forming a statistical characterization of a subsurface region surrounding the wellbore.

4. The method of claim 3, wherein the statistical characterization comprises a dip distribution, an azimuth distribution, and a hydraulic aperture distribution.

5. The method of claim 3, further comprising populating a discrete fracture network (DFN) model based, at least in part, on the statistical characterization.

6. The method of claim 5, further comprising predicting, using a reservoir simulator, a hydrocarbon production rate based, at least in part, on the DFN model.

7. The method of claim 1, wherein the image comprises an electrical conductivity image.

8. The method of claim 1, wherein the full waveform sonic dataset comprises a Stoneley dataset.

9. The method of claim 8, wherein the Stoneley dataset comprises a dominant frequency of less than 1 kilohertz.

10. The method of claim 1, wherein determining the hydraulic aperture comprises determining a Stoneley reflection coefficient.

11. The method of claim 10, wherein determining the Stoneley reflection coefficient comprises determining a frequency dependent reflection coefficient spectrum.

12. The method of claim 10, wherein determining the hydraulic aperture comprises determining an aggregate hydraulic aperture based, at least in part, on the Stoneley reflection coefficient and an image aperture determined from the image.

13. The method of claim 1, wherein identifying the location of each member of a plurality of fractures, comprises:
determining a meta-fracture from a set of fractures located within a depth interval of the wellbore based, at least in part, on a dominant wavelength of the full waveform sonic dataset; and
assigning a center of the depth interval to be the location of the meta-fracture.

14. The method of claim 1, wherein the wellbore imaging tool and the sonic logging tool are conveyed on an electrical wireline.

15. A non-transitory computer-readable memory having computer-executable instructions stored thereon that, when executed by a computer processor, causes the computer processor to perform steps comprising:
receiving, from a wellbore imaging tool, an image of a portion of a wellbore wall, wherein the wellbore penetrates a subsurface region of interest;
receiving, from a sonic logging tool, a full waveform sonic dataset for the portion;
identifying, using a well log interpretation system, a location of each member of a plurality of fractures in the image;
for each member of the plurality of fractures:
identifying a reflected sonic signal originating at the location of the fractures, and
determining, from the reflected sonic signal, a hydraulic aperture.

16. A system for determining a hydraulic fracture aperture within a subsurface region of interest, comprising:
a wellbore imaging tool, configured to obtain an image of a portion of a wellbore wall, wherein the wellbore penetrates the subsurface region of interest;
a sonic logging tool, configured to obtain a full waveform sonic dataset for the portion;
a well log interpretation system, configured to identify a location of each member of a plurality of fractures in the image; and
a full waveform sonic processing system:
configured to identify, for each member of the plurality of fractures, a reflected sonic signal originating at the location of the fractures, and
determine, for each member of the plurality of fractures, from the reflected sonic signal, a hydraulic aperture.

17. The system of claim 16, wherein the well log interpretation system is further configured to determine from the image a dip and an azimuth for each member of a plurality of fractures in the image.

18. The system of claim 16, wherein the image comprises an electrical conductivity image.

19. The system of claim 16, wherein the full waveform sonic processing system is further configured to form a statistical characterization of a subsurface region surrounding the wellbore, wherein the statistical characterization comprises a dip distribution, an azimuth distribution, and a hydraulic aperture distribution.

20. The system of claim 16, wherein the full waveform sonic dataset comprises a Stoneley dataset.
